(19) United States
(12) Patent Application Publication
(10) Pub. No.: US 2013/0139600 A1
(43) Pub. Date: Jun. 6, 2013

(54) Gunfire Detection

(71) Applicants: Magnus McEwen-King, Farnborough (GB); David John Hill, Dorchester (GB); Alastair Godfrey, Farnborough (GB)

(72) Inventors: Magnus McEwen-King, Farnborough (GB); David John Hill, Dorchester (GB); Alastair Godfrey, Farnborough (GB)

(73) Assignee: OPTASENSE HOLDINGS LIMITED, Hampshire (UK)

(21) Appl. No.: 13/816,902

(22) PCT Filed: Aug. 15, 2011
(86) PCT No.: PCT/GB11/01219

§ 371 Date: Feb. 13, 2013

(30) Foreign Application Priority Data
Aug. 16, 2010 (GB) 1013712.3

(51) Int. Cl. G01H 9/00

(52) U.S. Cl. CPC G01H 9/004
USPC 73/655

(57) ABSTRACT

An apparatus and method for detecting gunfire is provided which uses distributed acoustic sensing to provide the gunfire detection. The method comprises interrogating an optical fibre with electromagnetic radiation to provide a distributed acoustic sensor comprising a plurality of sensing portions of the optical fibre, and analysing a measurement signal from said sensing portions to detect gunfire events. A gunfire event will typically be relatively intense but of short duration and affect multiple sensing channels. The method may detect a characteristic 602 of a muzzle blast and/or a characteristic 601 of pressure wave from a supersonic round and may determine the location of the gunfire and the location at which the round crosses the sensor.

This invention relates to acoustic gunfire detection and location and in particular to gunshot detection and location using a fibre optic distributed acoustic sensor.

Gunshot detection systems are known for detecting gunfire and for locating the origin of the gunfire. Such systems have been proposed for battlefield use, for example for detecting sniper locations or, on a larger scale, for detecting the location of enemy artillery. Increasingly however it has also been proposed to use gunfire detection as part of civilian crime prevention and detection. For example gunfire detection systems may be deployed in an urban environment to detect and locate gunfire to enable a rapid police response, to either hostile criminal gun use or random gunfire. Urban sniper detection and location system may also be used for security for high profile events or locations.

Acoustic gunfire detection systems are known and typically comprise an array of microphones to detect pressure waves, i.e. acoustic events, associated with gunfire. Such acoustic systems may either detect the shock wave of the muzzle blast and/or a shock wave created by passage of the bullet through the air.

In general however such acoustic gunshot detection systems utilize an array of microphones which are arranged in the area to be monitored. Each microphone requires power which often means that each sensor module that is deployed in the array requires its own power source. Further in some environments the sensors modules need to be rugged to resist damage through vandalism, deliberate sabotage or battlefield conditions. Further there is a need to be able to receive data and process data from all of the sensors in real time in order to provide useable real-time information about the location of the origin of the gunfire. In some instances wireless communications have been proposed which requires power for the communications. Further wireless communications may be subject to interference and losses in highly populated urban area. Alternatively a wired network of sensors can be used but this may not always be practical and deployment of the sensors can be time consuming.

These conditions can lead to the use of relatively expensive and bulky sensor modules, in some instances with a limited battery life or a requirement to regularly replace or recharge battery units.

It is therefore an object of this invention to provide a gunfire detection and/or location system that at least mitigates some of the above mentioned disadvantages.

Thus according to the present invention there is provided a method of gunfire detection comprising interrogating an optical fibre with electromagnetic radiation to provide a distributed acoustic sensor comprising a plurality of sensing portions of the optical fibre; and analysing a measurement signal from said sensing portions to detect gunfire events.

The method of this aspect of the present invention uses distributed acoustic sensing to provide gunfire detection. Distributed acoustic sensing (DAS) is a known technique whereby a single length of optical fibre is interrogated, usually by one or more input pulses of light, to provide substantially continuous sensing of vibration activity along its length. Optical pulses are launched into the fibre and the radiation backscattered from within the fibre is detected and analysed. By analysing the radiation Rayleigh backscattered within the fibre the effect of vibrations of the fibre can be detected. The backscatter returns are typically analysed in a number of time bins, typically linked to the duration of the interrogation fibres and hence the returns from a plurality of discrete sensing portions can be separately analysed. Thus the fibre can effectively be divided into a plurality of discrete sensing portions of fibre. Within each discrete sensing portion mechanical vibrations or strains of the fibre, for instance from acoustic sources, cause a variation in the characteristics of radiation which is backscattered from that portion. This variation can be detected and analysed and used to give a measure of the intensity of disturbance of the fibre at that sensing portion. As used in this specification the term “distributed acoustic sensor” will be taken to mean a sensor comprising an optical fibre which is interrogated optically to provide a plurality of discrete acoustic sensing portions distributed longitudinally along the fibre and acoustic shall be taken to mean any type of mechanical vibration or pressure wave, including seismic waves. The method may therefore comprise launching a series of optical pulses into said fibre and detecting radiation Rayleigh backscattered by the fibre; and processing the detected Rayleigh backscattered radiation to provide a plurality of discrete longitudinal sensing portions of the fibre. Note that as used herein the term optical is not restricted to the visible spectrum and optical radiation includes infrared radiation and ultraviolet radiation. A suitable DAS system is described in GB2442745 for example, the content of which is hereby incorporated by reference. Such a sensor may be seen as a fully distributed or intrinsic sensor as it uses the intrinsic scattering processed inherent in an optical fibre and thus distributes the sensing function throughout the whole of the optical fibre.

The method of the present invention therefore uses DAS to provide an acoustic gunfire detection system.

The method may comprise analysing the measurement signals from each of the plurality of sensing portions of the fibre to detect an acoustic event which is characteristic of gunfire. The method may therefore comprise analysing the measurements signals from the sensing portions of fibre to detect an acoustic signature associated with gunfire.

Gunfire typically produces an intense muzzle shock wave on firing. This is a relatively intense shock wave and hence may propagate much further than other acoustic sources produced in the environment. In a typical urban environment there may be lots of noise sources in normal daytime circumstances. However these sources may be relatively low intensity. Thus the acoustic signals from such acoustic sources may not propagate very far. By contrast the shock wave from gunfire may propagate for quite some distance. The method may therefore involve detecting a relatively intense signal in various remote sections of the fibre. If the same general acoustic disturbance is detected in several sections of the fibre that are remote from one another this could be used as an indication of an especially intense acoustic event which could be identified as possible gunfire.

The evolution of the acoustic signals may also be used to characterise gunfire. Imagine that a sensing fibre is arranged in a straight line and interrogated so as to provide a plurality of contiguous sensing portions of fibre. If a gun is fired to one side of the fibre the muzzle shock wave will travel through the air and will impinge at a first time on the nearest section of sensing fibre. The shock wave will also travel to other sections of fibre which are further away however and will arrive slightly later due to the finite propagation speed of the shock wave. An intense shock wave will however travel a relatively long distance and thus will disturb several sections of fibre. Unsuppressed gunshots can be heard in urban environments for a kilometre or more against normal daytime background noise and from further away in quieter periods such as at night. Thus a shock wave from gunshot could disturb hundreds of different sensing portions of the fibre in turn. Were a waterfall type plot (showing time on one axis and position along the fibre on another axis and plotting the intensity of the acoustic disturbances) to be produced for such a linear fibre the shock wave will appear as a characteristic shape, which may be a generally curved V shape (or in some instances a straight sided V shape)—due to the shock waves propagating the other sections of the fibre. For a rectilinear fibre arrangement such a curved V shape could represent the acoustic signature of an intense acoustic event. Clearly in other fibre arrangements the various sensing portions of the fibre may have a more complicated relative positioning and hence the evolution of any acoustic disturbance may be different but as long as the general arrangement of the sensing portions of the fibre are known the characteristic evolution of the signal can be determined. In some instances once the fibre has been deployed several test events similar to gunfire could be initiated and the response to such test events detected and used as the basis for future detection. The evolution of such an acoustic disturbance in adjacent sensing portions of the fibre can be used to identify that acoustic disturbances at remote parts of the fibre are due to same intense event and such detection may be used as an indication of gunfire.

The method may also involve analysing the frequency of the acoustic disturbance to distinguish from other acoustic events. The spectral characteristics of gunfire may be different to many of the typical noise sources in the environment, especially in normal urban environments. Thus the method may comprise identifying an acoustic disturbance as having the spectral characteristics of gunfire.

Gunfire also leads to an intense but relatively short acoustic event. The duration of an acoustic disturbance may also be used to determine a gunfire event. Thus detection of a relatively intense acoustic event which affects a number of spatially separated channels of a DAS sensor and which has a short duration can be used as an indication of a gunfire event.

The method may also comprise identifying an acoustic signature associated with non-gunfire events in order to avoid false alarms. For example spectral or temporal characteristics associated with expected sources of noise, for example general traffic noise or a dog bark say, may be used to identify acoustic disturbances that are not-gunfire related. A combination of relative intensity, spectral analysis, signal evolution over multiple channels and/or temporal analysis for an individual channel may be used to categorise events.

Further the method may comprise applying one or more filters based on the time of day and/or known events. For example the relative intensity required to generate a gunfire alarm may vary between daytime and night time and at different parts of the day.

When a gunfire event is detected the method may generate an alarm. The alarm may be visible, on a graphical display, or audible or both and/or may comprise generating an automatic notification.

Preferably the method comprises not only detecting gunfire events but also detecting the location of origin of gunfire. Various techniques can be used to determine the location of origin of gunfire.

As mentioned above when a shot is fired, from a position transverse to the general path along with the fibre is deployed, the muzzle blast shock wave will spread out from the location of firing until it is incident on the sensing fibre and will affect the various sensing portions of fibre as it spreads outward. This will lead to the characteristic curved V type shape that starts with the sensing portion nearest to the firing location. Thus for a rectilinear type fibre arrangement, where a relative intense and short duration disturbance is detected by a number of channels of the DAS sensor in turn, resulting in a curved feature in a waterfall plot, the channel which detects the event at the earliest time can be identified as being transversely in line with the origin of the shock wave. Additionally any two spatially separated sensing portions of optical fibre that detect the shock wave event at the same time can be taken to equidistant from the origin of the shock wave. Depending on the fibre arrangement the detection of the muzzle blast shock wave at various different sensing portions of the fibre may therefore allow the origin of the shock wave to be identified simply by identifying those sections of fibre which detected the shock wave at the same time as one another. For a rectilinear type arrangement however this may give the heading to the origin of the shock wave, and hence position from which the shot was filed, but not the range.

The range can however be determined by looking at how quickly the shock wave is detected by different portions of the optical fibre. The muzzle blast shock wave will travel at the speed of sound, i.e. about 330 ms⁻¹. Were the gun to be fired directly above a sensing fibre arranged in a linear pattern then a first sensing portion directly under the shot location would detect the muzzle blast straight away. The muzzle blast shock wave would then travel in both directions along the fibre at a speed of about 330 ms⁻¹. Thus a second sensing portion of fibre which is 300 m away from the first sensing portion would only detect the muzzle blast shock wave nearly a second after first sensing portion. In this instance the waterfall plot would exhibit a V shape with a gradient of each slope equal to about 330 ms⁻¹. Now however consider the gun was fired from a location which was 500 m away from the first sensing portion in a direction perpendicular to the fibre. In this instance when the gun the muzzle blast shock wave will spread outwards and will be detected initially be the first sensing portion as before. Again the shock wave will also travel and impinge on the other sensing portions in time. In this scenario however the shock wave needs to travel 500 m to reach the first sensing portion. the distance between the firing location and the second sensing portion in this example is (through trigonometry) is a little under 585 m. Thus in this example there is only just under 85 m difference in the distances from the firing location to the first and second sensing portions. Hence the muzzle blast shock wave will be detected by the second sensing portion only about 0.25 s it is detected by the first sensing portion. In this situation the gradient in the waterfall plot seems to indicate a velocity along the fibre of much greater than 330 ms⁻¹. Thus by determining the time difference between the time of arrival of the shock wave at two or more distinct sensing portions the relative difference in range from the origin can be determined and, with knowledge of the spatial separation of the two or more sensing portions the absolute range to the origin of the shock wave, and hence location of gunfire can be determined.

In some embodiments the fibre may be arranged such that at least three sensing portions of fibre, that are not arranged co-linearly, can each detect the same acoustic disturbance. In an urban environment with many buildings at least some sensors may be obstructed but with several sensors arranged at different locations the general time of arrival in different areas may be determined and used to locate the general area of the origin of the gunfire using multilateration techniques as would be understood by one skilled in the art.

The method may therefore comprise interrogating an optical fibre which is arranged so that the multiple sensing portions are not arranged co-linearly. Additionally or alternatively the method may comprise interrogating at least one additional fibre wherein the sensing portions of the additional fibre are not co-linear with those of the first fibre.

In one embodiment the optical fibre is arranged to describe a generally ring-shapes arrangement, e.g. substantially circular or elliptical, with the circumference of the ring being significantly larger than the length of the sensing portions of fibre. For instance the circumference of the ring may be at least twenty times the length of an individual sensing portion. A gunfire event which generates a shock wave that passes over the ring will be detected by various sensing portions of the fibre at different times and this can be used to determine the genera location of the origin of the gunfire event.

The discussion above has focussed on the detection of muzzle blast shock waves. In some instances however the propagation of a supersonic bullet can also give rise to a shock wave which can be detected. The method may therefore also comprise identifying the characteristics of shock wave due to a supersonic bullet. This is principally applicable to detection of long range rifle gunfire.

A supersonic bullet will create a pressure wave as it passes through the air. Thus detection of the supersonic shock wave will be detection of a shockwave created as the bullet passed the optical fibre. Thus on the waterfall plot the disturbance will appear as the characteristic V shape and the disturbance will propagate along the fibre with an apparent speed of about 330 ms⁻¹. The sensing portion of fibre which first detects the shock wave will the location at which the bullet passes the fibre. In this instance therefore detecting the point of origin would generally reveal where the bullet passed in relation to the fibre.

Detecting whether a bullet has crossed a particular border or perimeter is useful in detecting fence line shootings and the like and DAS offers a very useful way of monitoring for whether shots have been fired across a perimeter.

In some instances it may be possible to detect a muzzle blast shock wave, which can be used to determine the point of origin of the gunfire. In some cases it might be possible to detect the shock wave due to propagation of a supersonic bullet. This can allow detection of where the bullet crosses the fibre. A supersonic shock wave will generally lead to V shape pattern in a waterfall plot which has a velocity of 330 ms⁻¹ along the fibre (if arranged in a straight line but the principles are the same for curved arrangements) whereas a muzzle blast shock wave is likely to have a point of origin displaced from the fibre and thus will lead to an apparent velocity along the fibre which can be significantly greater. Thus the two types of shock wave can be discriminated, and if the point of origin was at the fibre location the very intense disturbances detected in the vicinity of the firing location may distinguish from a supersonic shock wave.

In some cases it may be possible to detect both the supersonic shock wave and the muzzle blast shock wave. The supersonic shock wave would be detected first, as the bullet is travelling faster than the speed of sound and so would reach the fibre before the muzzle blast. This would lead to a supersonic shock wave which is first detected at the point where the bullet crosses the fibre and which spreads out along the fibre at the speed of sound (assuming the fibre is straight). Shortly afterwards, at a time dependent on the distance of the location of the shot from the fibre the muzzle blast shock wave may be detected and this would spread out along the fibre with an apparent velocity greater then the speed of sound where the exact value depends on the distance from the gunfire to the fibre.

By determining the range to the point of origin of the gunfire, and also the travel time of the shock wave, together with the point and time at which the bullet crossed the fibre not only the location of the gunfire origin but also the speed and trajectory of the bullet can be determined.

The use of DAS to provide gunfire detection offers several advantages.

As mentioned each sensing portion of fibre acts as a discrete sensor. However power is only required to launch optical radiation into the fibre and to detect backscattered radiation at the same end of the fibre. Thus power is only required at one end of the fibre. This greatly reduces the requirement to provide power to a plurality of different sensors.

A single length of standard telecoms optical fibre may be used as the sensing fibre. An unmodified, substantially continuous length of standard fibre can be used, requiring little or no modification or preparation for use. Optical fibre is relatively cheap and can be deployed relatively easier. In some applications the fibre may simply be laid on the ground, which allows for easy of deployment. In other implementation implementations however, for example for more permanent monitoring for certain locations, the fibre may be buried. Use of buried fibre is advantageous as it is not conspicuous, it is protected by being buried and it is harder to detect and sabotage.

The fibre can be divided into a large number of discrete sensing portions. For example a fibre which is 40 km long can be divided into sensing portions, each of which corresponds to a 10 m length of fibre. Thus the fibre can be operated as a chain of 4000 contiguous acoustic sensors, each effectively 10 m apart. The fibre can then be deployed in any geometry to provide the required coverage. The minimum spatial length of each sensing portion of fibre depends on the properties of the interrogating radiation as will be understood by one skilled in the art, as does the overall length of fibre that can be interrogated. The actual spatial resolution of the sensor system can also be controlled by the deployment of the fibre. For example even if the length of the individual sensing portions of fibre is 10 m, if the fibre is wound so that 10 m of fibre cover only 1 m, of ground the effective spatial resolution is 1 m.

As mentioned above the length and arrangement of the sensing portions of the fibre is, at least partly, determined by the interrogation of the fibre and thus these can be selected according to the physical arrangement of the fibre and, if necessary the length of the individual sensing portions of fibre, and the distribution of the channels may be varied during use, for example in response to the detected signals. This may be particularly advantageous in some environments where echoes or other multipath acoustic events may result in difficult in detecting gunfire events in certain locations. Changing to a different sensor length or moving the relative position of the sensors along the fibre may allow such effects to be detected or overcome more easily than with a conventional fixed array of point sensors.

DAS provides real time monitoring capability. In other words the measurement signals for the sensing portions of the fibre are provided without any significant delay and are a generally accurate representation of the acoustic signals being currently detected by the distributed acoustic sensor.

Optical fibres may be deployed specifically for the purposed of gunfire detection. As mentioned above for a temporary or rapid deployment a fibre optic could be deployed on the ground in a desired arrangement with an interrogator at one end. Alternatively, for a more secure or permanent deployment a fibre optic could be buried along a predetermined route, for example in a channel about 0.5 m underground or the like. The buried fibre is still able to detect gunfire events but is more secure from tampering and more concealed.

In some instances however it may be possible to use existing fibre optics. Many urban areas have existing fibre optic cables for communications and such cable may run in an intersecting network. Some of these fibres could be interrogated in order to provide a network of sensors without requiring additional deployment. For example redundant fibres in the fibre bundle could be used or the interrogation could multiplexed with existing uses of the fibres.

When using existing fibres the exact deployment of the fibres may not be known exactly. However in this case a number of calibration events could be conducted, i.e. setting off known acoustic sources at known locations and monitoring the fibres to determine the overall response. In this way the general arrangement of the fibres can be determined.

The invention also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

A further aspect of the invention provides apparatus for gunfire detection comprising: an optic fibre interrogator adapted to interrogate an optic fibre and provide distributed acoustic sensing; and a processor adapted to receive sensed data from said interrogator and detect an acoustic signature associated with gunfire. The processor may also be adapted to determine the location of said pig.

The apparatus according to this aspect of the invention provides all of the same advantages and may utilize of all the same embodiments as described above with reference to the first aspect of the invention.

The invention is applicable to detection of all types of guns. The invention may be used as a stand alone gunfire detection or may be integrated with other sensors such as optical muzzle flash or bullet trajectory detectors.

The invention extends to methods, apparatus and/or use substantially as herein described with reference to the accompanying drawings. Any feature in one aspect of the invention may be applied to other aspects of the invention, in any appropriate combination. In particular, method aspects may be applied to apparatus aspects, and vice versa.

Furthermore, features implemented in hardware may generally be implemented in software, and vice versa. Any reference to software and hardware features herein should be construed accordingly.

The invention will now be described by way of example only with reference to the following drawings, of which:

FIG. 1 illustrates the basic components of a distributed fibre optic sensor;

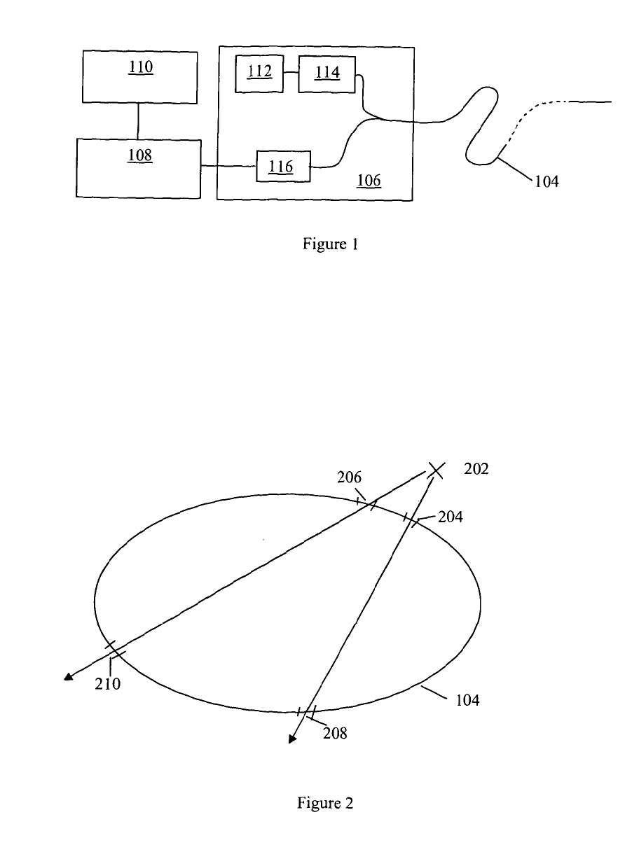

FIG. 2 illustrates a sensing fibre and illustrates the longitudinal sensing portions of the fibre;

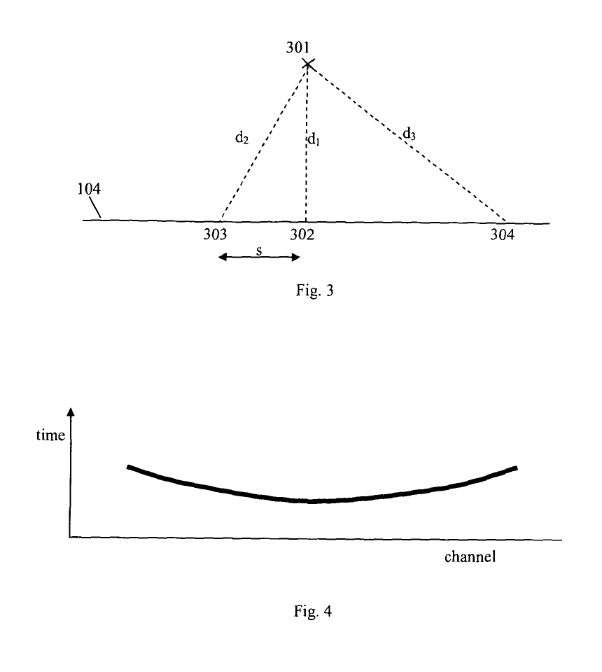

FIG. 3 illustrates use of a sensing fibre deployed along a perimeter;

FIG. 4 illustrates a waterfall plot of outputs from a sensing fibre;

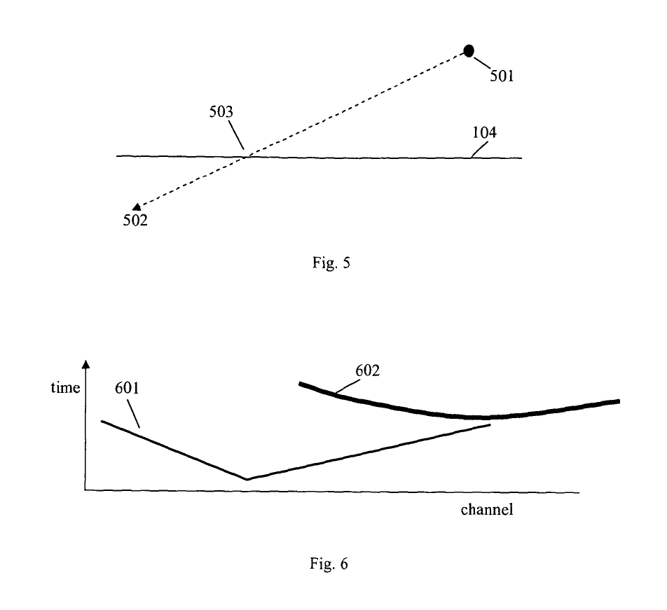

FIG. 5 illustrates a further use of a sensing fibre;

FIG. 6 illustrates a further waterfall plot of outputs from a sensing fibre.

FIG. 1 shows a schematic of a distributed fibre optic sensing arrangement. A length of sensing fibre 104 is connected at one end to an interrogator 106. The output from interrogator 106 is passed to a signal processor 108, which may be co-located with the interrogator or may be remote therefrom, and optionally a user interface/graphical display 110, which in practice may be realised by an appropriately specified PC. The user interface may be co-located with the signal processor or may be remote therefrom.

The sensing fibre 104 can be many kilometres in length, and in this example is approximately 40 km long. The sensing fibre is a standard, unmodified single mode optic fibre such as is routinely used in telecommunications applications. In conventional applications of optical fibre distributed sensors the sensing fibre is at least partly contained within a medium which it is wished to monitor. For example, the fibre 104 may be buried in the ground to provide monitoring of a perimeter or monitoring of a buried asset such as a pipeline or the like.

The invention will be described in relation to a distributed acoustic sensor, although the skilled person will appreciate that the teaching may be generally applicable to any type of distributed fibre optic sensor.

In operation the interrogator 106 launches interrogating electromagnetic radiation, which may for example comprise a series of optical pulses having a selected frequency pattern, into the sensing fibre. The optical pulses may have a frequency pattern as described in GB patent publication GB2,442,745 the contents of which are hereby incorporated by reference thereto. As described in GB2,442,745 the phenomenon of Rayleigh backscattering results in some fraction of the light input into the fibre being reflected back to the interrogator, where it is detected to provide an output signal which is representative of acoustic disturbances in the vicinity of the fibre. The interrogator therefore conveniently comprises at least one laser 112 and at least one optical modulator 114 for producing a plurality of optical pulse separated by a known optical frequency difference. The interrogator also comprises at least one photodetector 116 arranged to detect radiation which is backscattered from the intrinsic scattering sites within the fibre 104.

The signal from the photodetector is processed by signal processor 108. The signal processor conveniently demodulates the returned signal based on the frequency difference between the optical pulses such as described in GB2,442,745. The signal processor may also apply a phase unwrap algorithm as described in GB2,442,745.

The form of the optical input and the method of detection allow a single continuous fibre to be spatially resolved into discrete longitudinal sensing portions. That is, the acoustic signal sensed at one sensing portion can be provided substantially independently of the sensed signal at an adjacent portion.

The present invention uses at least one fibre optic sensor for gunfire detection. The returns from each sensing section of fibre are analysed for a characteristic signature of a gunshot. Typically this is a relatively intense but short duration event which propagates to several of the sensing portions of the fibre and whose spectral and temporal characteristics don't correspond to a non-gunfire event.

FIG. 2 illustrates a gunfire event at a location 202. The optical fibre 104 of a DAS sensor is arranged in a ring shape to detect gunfire in the vicinity. As the shot is fired a muzzle blast shock wave will propagate outwards from the gun. The shock wave may be more intense in some directions than other depending on the type of gun and whether a suppressor is used, but generally the shock wave will propagate outwards. The shock wave will first encounter the sensing portions of the fibre on the same side of the fibre as the gunshot. All sensing portions of fibre on that side of the ring will detect the gunfire in time before eventually the shock wave reaches the other side of the fibre. The evolution of the disturbance can be used to characterise the disturbances as gunfire along with the intensity.

If a gunfire event is detected by spectral processing the system then determines the location of the origin of the gunfire. Various multilateration type techniques are known. In FIG. 2 it can be seen the shock wave will reach sensing portions 204 and 206 before portions 208 and 210 and the relative time of arrival can be used to determine the location 202. An alarm can then be generated indicating that a gunfire event has been detected and giving the location of the origin.

Embodiments of the present invention can however detect gunfire events and categorise the gunfire event and determine the position from which the gunfire originated and/or the position at which a bullet passes a perimeter and in some instances the trajectory and speed of the bullet.

With reference to FIG. 3 a sensing fibre may be deployed in a generally straight line along a perimeter to be monitored. In some instances it is wished to monitor for gunfire over a perimeter for instance for fence line shooting detection. Ideally the location of the gunfire and the direction of shooting should be determined.

Imagine that a shot is fire from a first location 301. The muzzle blast from the gunfire will create a shock wave that will generally propagate in all directions, at least in the general direction of firing. The shock wave will propagate at the speed of sound and may be detected by one or more channels of the DAS sensor. As mentioned above the muzzle blast shock wave will typically be a relatively intense acoustic signal that may travel quite far and thus will be detected by many spatially separated channels of the DAS sensor. As the shock wave will travel in all directions at substantially the same speed it will first be detected by a sensing portion 302 of fibre which has the shortest straight line distance to the origin 301 of the shock wave. For a straight sensing fibre and an origin which is located off to one side of the fibre this will be the sensing portion that is in line with the origin in a direction perpendicular to the fibre 104.

As the shock wave travels it will be detected by other sensing portions of fibre, depending on the distance between the origin 301 and the sensing portion. Thus the shock wave will arrive a sensing portion 303 which is a distance d₂ from the origin before it arrives at sensing portion 304 which is a distance d₃ from the origin, where d₃>d₂.

FIG. 4 illustrates a waterfall type plot of the output from the various channels along the sensing fibre 104 against time. It can be seen that effect of the muzzle blast shock wave is a relatively intense disturbance that is detected by many channels of the DAS sensor and which has a short duration. The propagation of the shock wave results in a curved V type feature in the waterfall plot. The processor of a DAS based gunfire detection system may therefore look for such a curved v type feature across many channels but with a short duration in order to detect a gunfire event.

The processor may then determine the position along the fibre at which the acoustic signal was first detected. In this instance sensing portion 302. The point of origin can then be determined to be at this location along the fibre but, at present, an unknown range away from the fibre. The time between arrival of the acoustic signal at this sensing portion and another sensing portion, say sensing portion 303 can then be determined, i.e. Δt=t₁−t₂. This value of Δt can be used to determine the difference in path length from sensing portion 303 to the origin 301 compared with sensing portion 302 using a suitable value for the speed of sound (which may be a default value for that location or could be measured periodically by using an acoustic source at a known location). This will therefore give a path length different value d₂−d₁.

Knowing the spatial separation, s, of the two sensing portions the range of the origin from the sensing portion 302 can then be determined using simple trigonometry.

The same principles can be applied without using the time of arrival at sensing portion 302 but instead using the time of arrival at multiple different sensing locations.

Thus the gunfire detection system according to the present invention can detect the location of the origin of gunfire.

Embodiments of the present invention can also detect a shock wave caused by passage of a supersonic bullet. The passage of a supersonic bullet may cause a pressure wave to travel along the optical fibre. As it is the passage of the bullet that causes the supersonic shock wave to radiate outwards the point of origin will be at the part of the fibre where the bullet or projectile crosses the fibre and the time take for the shock wave to travel along the fibre will be, for a straight fibre, generally equal to the speed of sound. Thus the characteristic in the waterfall plot will be a more straight sides V shape with an apparent velocity along the fibre that corresponds to the speed of sound. The difference in the characteristics of the muzzle blast shock wave, which will, in many applications, typically happen at some stand-off from the fibre, and the pressure wave from the bullet passage may allow discrimination between the two type of gunfire events when only one is detected.

Detection of both events however can allow the bullet trajectory and speed to be determined. For example consider FIG. 5 in which a supersonic round is fired from a first location 501 across the sensing optical fibre 104 in a direction indicated by arrow 502. As the round is supersonic the bullet may cross the fibre before the muzzle blast shock wave is detected (depending on the range and angle of fire). Thus pressure wave from the bullet passage is first detected at sensing location 503 and the waterfall plot illustrated in FIG. 6 would show the characteristic V feature 601 centred on location 503. The gradient of the sides of the V feature will correspond to the speed of sound. A short time later the muzzle blast shock wave will be detected in the location nearest to the origin of the gunfire. This will spread through the sensing channels at an apparent speed which is greater than the speed of sound as indicated by feature 602 in FIG. 6.

If both features are detected the location of the origin of the shot can be determined as described above. Further once the location of the shot has been established the time at which the shot was fired can be determined by considering the time of travel of the muzzle blast shock wave and extrapolating backwards from when the muzzle shock wave was detected. The time and location at which the round passes the fibre can be determined by looking at the apex of feature 601. From this information the velocity and trajectory of the bullet can be determined as well as the location of the shooter.

It will be apparent that these techniques could applied to other fibre arrangement than linear arrangement with suitable adjustments made to the calculations.

1. A method of gunfire detection, comprising:
interrogating an optical fibre with electromagnetic radiation to provide a distributed acoustic sensor comprising a plurality of sensing portions of the optical fibre; and
analysing a measurement signal from said sensing portions to detect an acoustic event characteristic of gunfire.

2-3. (canceled)

4. A method according to claim 1, further comprising
determining an evolution of the measurement signal along the length of the optical fibre portions to detect an acoustic event characteristic of gunfire.

5. A method according to claim 1, further comprising:
analysing the frequency of the acoustic disturbance to detect a spectral characteristic of gunfire to distinguish the acoustic disturbance from other acoustic events.

6. A method according to claim 1, wherein the measurement signal is determined to be an acoustic event characteristic of gunfire if the intensity of the is substantially larger than the background noise and the duration of the acoustic event is relatively short.

7. A method according to claim 1, the method further comprising identifying acoustic signatures associated with non-gunfire events.

8. A method according to claim 1, further comprising applying one or more filters based on the time of day and/or known events.

9. A method according to claim 8, wherein the filter requires the relative intensity required to generate a gunfire alarm to vary between daytime and night time and at different parts of the day.

10. (canceled)

11. A method according to claim 1, further comprising:
detecting the location of origin of gunfire.

12. A method according to claim 11, wherein the time of detection of an identified gunfire event at various different sensing portions of the fibre is used to locate the direction and/or range to origin of the acoustic event.

13. A method according to claim 12, wherein when at least three sensing portions of optical fibre, that are not arranged co-linearly, each detect the same acoustic disturbance, the time of arrival of the acoustic disturbance at the different sensing portions is used to determine the direction of the acoustic disturbance

14. (canceled)

15. A method according to claim 1, wherein the method comprises interrogating at least one additional fibre wherein the sensing portions of the additional fibre are not co-linear with those of the first fibre.

16. A method according to claim 1, wherein the optical fibre is arranged to describe a generally ring-shaped arrangement, with the circumference of the ring being significantly larger than the length of the sensing portions of fibre.

17. A method according to claim 16, wherein the circumference of the ring is at least twenty times the length of an individual sensing portion.

18. A method according to claim 1, further comprising identifying the characteristics of a shock wave due to a supersonic projectile.

19. A method as claimed in claim 18 wherein a detection event due to a muzzle blast shock wave is discriminated from a pressure wave caused by a supersonic projectile by analysing the time of detection of the disturbance at different portions of the sensing fibre.

20. A method as claimed in claim 18 comprising using a detection of a shock wave due to a supersonic projectile to determine the location at which said supersonic projectile crosses the optical fibre.

21. A method as claimed in claim 18 comprising detecting both an acoustic signal due a pressure wave caused by passage of a supersonic projectile and a muzzle blast shock wave.

22. A method as claimed in claim 21 comprising determining the origin of the muzzle blast shock wave and the location at which the projectile crosses the optical fibre and then determining the speed and/or trajectory of the projectile.

23. (canceled)

24. A method according to claim 1, wherein the fibre optic is an existing redundant fibre optic cable for communications.

25. A method according to claim 24, further comprising performing calibration to determine the configuration of the existing optical fibre, by setting off known acoustic sources at known locations and monitoring the fibres to determine the overall response.

26. A method according to claim 1 when said step of interrogating an optical fibre comprises launching a series of optical pulses into said fibre and detecting radiation Rayleigh backscattered by the fibre; and processing the detected Rayleigh backscattered radiation to provide a plurality of discrete longitudinal sensing portions of the fibre.

27. (canceled)

28. An apparatus for gunfire detection, comprising:
an optic fibre interrogator adapted to interrogate an optic fibre and provide distributed acoustic sensing; and
a processor adapted to receive sensed data from said interrogator and detect an acoustic signature associated with gunfire.

29-30. (canceled)
